(19) United States
(12) Patent Application Publication
(10) Pub. No.: US 2015/0146365 A1
(43) Pub. Date: May 28, 2015

(54) MEMORY EXPANSION APPARATUS

(71) Applicant: CHANT SINCERE CO., LTD., New Taipei City (TW)

(72) Inventor: Chih-Chien LIN, New Taipei (TW)

(21) Appl. No.: 14/548,379

(22) Filed: Nov. 20, 2014

(30) Foreign Application Priority Data
Nov. 22, 2013 (TW) 102142703
Jan. 16, 2014 (TW) 103200887

(51) Int. Cl. G06F 1/18

(52) U.S. Cl. CPC G06F 1/18
USPC 361/679.32

(57) ABSTRACT

A memory expansion apparatus, comprising: a chassis, wherein a receiving space is generated in one side of the same; a printed circuit board (PCB) configuring a principle interface and a loading interface, said PCB mounting within said chassis, two interfaces sharing no common export; and a memory article is provided with said loading interface, wherein said principle interface exposing in said receiving space.

### BACKGROUND OF THE INVENTION

1. Field of the Invention

The present invention relates generally to a memory expansion apparatus, and more specifically, to a memory expansion apparatus expansible memory unit to existing devices.

2. Description of the Related Art

U.S. Pat. No. 3,970,999, title as: Memory expansion apparatus, addresses large memories in a computer through the use of translation tables, associated control circuitry, and an appropriate set of instructions. U.S. Pat. No. 6,222,726, portable personal computer with arrangement for connecting an expansion card to a socket therein, discloses the housing of a palm-sized computer consists of a top housing part having an upper surface, side surfaces and an opened bottom and a bottom housing part for covering the opened bottom to enclose an electronic circuit board. The housing is provided with an expansion card arrangement for electrically connecting an expansion card with the electronic circuit board, which comprises an card insertion opening formed on one side of the housing for inserting the expansion card into the housing, a socket formed on the electronic circuit board to electrically connect the expansion card with the electronic circuit board, the opening of the socket directly facing the card insertion opening, and a guide support integrally formed with the housing between the card insertion opening and the socket so as to guide and support the expansion card inserted through the card insertion opening into the socket.

U.S. Pat. No. 6,599,147, high-density removable expansion module having I/O and second-level-removable expansion memory, has mentioned the utility of portable computer hosts, such as PDAs (or handhelds), is enhanced by methods and apparatus for removable expansion cards having application specific circuitry, a second-level-removable memory, and optional I/O, in a number of illustrative embodiments. In addition to providing greater expansion utility in a compact and low profile industrial design, the present invention permits memory configuration versatility for application specific expansion cards, permitting easy user field selection and upgrades of the memory used in conjunction with the expansion card. Finally, from a system perspective, the present invention enables increased parallelism and functionality previously not available to portable computer devices. U.S. Patent application Publication No. 20090177853, system and methods for memory expansion, discusses, among other things, an example system and methods for memory expansion. An example embodiment includes detecting a memory command directed to a logical rand and a number of physical ranks mapped to the logical rank. The example embodiment may also include issuing the memory command to the number of physical ranks based on determining that the memory command is to be issued to the number of physical ranks.

Above apparatus and inventions provide the ancient solutions for the past, however, there still are demands drawing a better way to meet the technology change today.

### SUMMARY OF THE INVENTION

For solving the situation occurred in the conventional art, therefore, it is necessary to modify and to find an improved apparatus for accommodating memory, thereto providing a solution to mount a memory article into an original configuration itself.

The present invention is ultimately to provide a memory expansion apparatus, comprising: a chassis, wherein a receiving space is generated in one side of the same; a printed circuit board (PCB) configuring a principle interface and a loading interface, said PCB mounting within said chassis, two interfaces sharing no common export; and a memory article is provided with said loading interface, wherein said principle interface exposing in said receiving space.

Wherein, said chassis consists of a body and frame.

Wherein, a plurality of recessions is disposed with the edges of the chassis facing said receiving space.

Wherein, one edge particularly disposes a cavity.

Wherein, said memory article is an external memory card is movably attached to back of apparatus.

Wherein, said printed circuit board further configuring a supplementary interface.

Wherein, said principle interface is configured with an I/O connector.

Wherein, said loading interface is configured with a card connector.

Wherein, said loading interface includes a case and a chamber to form a card connector.

Wherein, a microprocessor is mounted upon the PCB.

Wherein, said loading interface 300 is located within the protrude portion 102.

Wherein, said principle interface is disposed to said PCB.

Wherein, said loading interface is disposed under said PCB.

Wherein, said protrude portion is configured with an opening

Wherein, said loading interface provided with a bonding portion.

Wherein, said loading interface is configured with an electrical board, which is adopted by chip on board (COB) or system in package (SIP).

Wherein, said electrical board integrating a microprocessor, memory and other electronic components in one package.

Wherein, a battery module is configured on the back of the chassis.

Wherein, a wiring is configured on the back of the chassis.

### BRIEF DESCRIPTION OF THE DRAWINGS

FIG. 1 is a top perspective view of the memory expansion apparatus formed in accordance with an embodiment of the invention.

FIG. 2 is a bottom perspective view of the memory expansion apparatus formed in accordance with an embodiment of the invention.

FIG. 3 is an exploded perspective view of the memory expansion apparatus formed in accordance with an embodiment of the invention.

FIG. 4 is a top perspective view of PCB parts of the memory expansion apparatus formed in accordance with an embodiment of the invention.

FIG. 5 is a top view of the memory expansion apparatus shown in FIG. 1.

FIG. 6 is another bottom perspective view of the memory expansion apparatus formed in accordance with an embodiment of the invention.

FIG. 7 is a bottom perspective view of PCB parts of the memory expansion apparatus formed in accordance with an embodiment of the invention.

FIG. 8 is further a bottom perspective view of PCB parts of the memory expansion apparatus formed in accordance with an embodiment of the invention.

FIG. 9 is another bottom perspective view of PCB parts of the memory expansion apparatus formed in accordance with an embodiment of the invention.

FIG. 10a is a front view of the memory expansion apparatus formed in accordance with an embodiment of the invention.

FIG. 10b is a cross-section view of the memory expansion apparatus taken along line A-A in FIG. 10a.

FIG. 10c is a cross-section view illustrated details of the memory expansion apparatus shown in FIG. 10b Detail A.

FIG. 11 is a reverse rear view of the memory expansion apparatus formed in accordance with an embodiment of the invention.

FIG. 12 is a further reverse rear view of the memory expansion apparatus formed in accordance with an embodiment of the invention.

FIG. 13 is another reverse rear view of the memory expansion apparatus formed in accordance with an embodiment of the invention.

FIG. 14 is a straight perspective view of the memory expansion apparatus illustrated a status before connecting with a portable device.

FIG. 15 is a straight perspective view of the memory expansion apparatus illustrated a status after connecting with a portable device.

FIG. 16 is a block diagram of the memory expansion apparatus formed in accordance with an embodiment of the invention.

FIG. 17 is a further block diagram of the memory expansion apparatus formed in accordance with an embodiment of the invention.

FIG. 18 is another block diagram of the memory expansion apparatus formed in accordance with an embodiment of the invention.

### DETAILED DESCRIPTION OF THE EMBODIMENT(S)

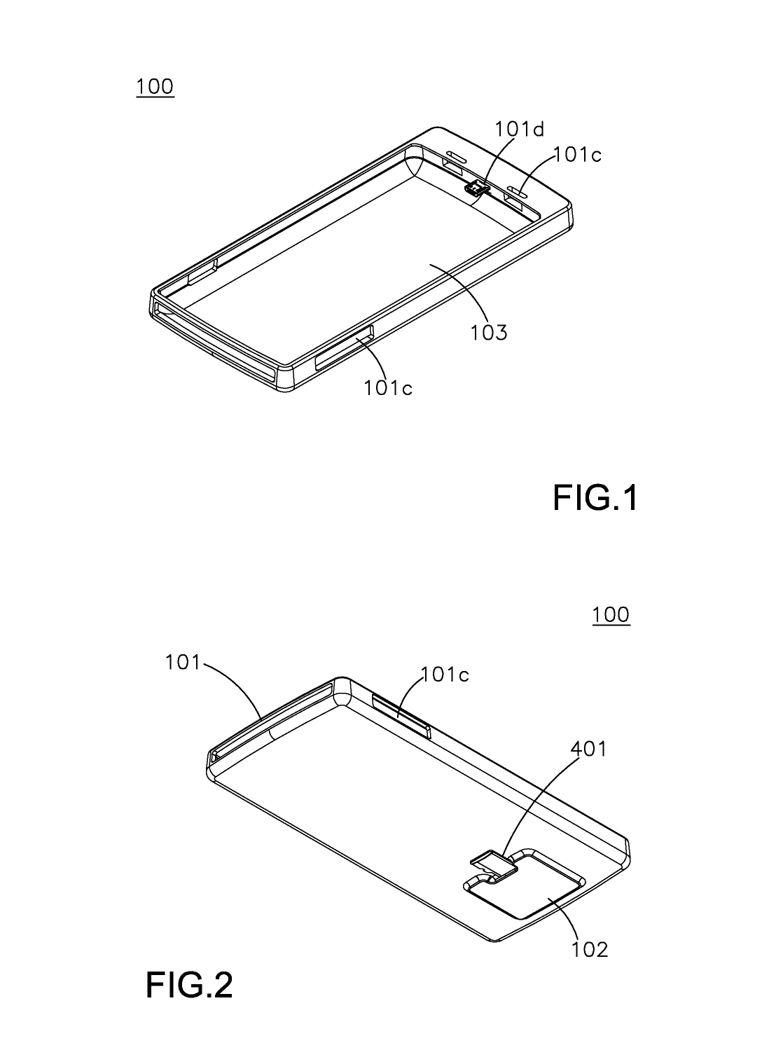

FIG. 1 is a top perspective view of the memory expansion apparatus formed in accordance with an embodiment of the invention. FIG. 2 is a bottom perspective view of the memory expansion apparatus formed in accordance with an embodiment of the invention.

As shown in FIGS. 1-2, a memory expansion apparatus 100, generally, is configured with a chassis 101, wherein a receiving space 103 is generated in one side of the same. A plurality of recessions 101c is disposed with the edges of the chassis 101 facing the receiving space 103 where one edge particularly disposes a cavity 101d. An external memory card 401 is movably attached to back of apparatus 100 and is accommodated in a protrude portion 102.

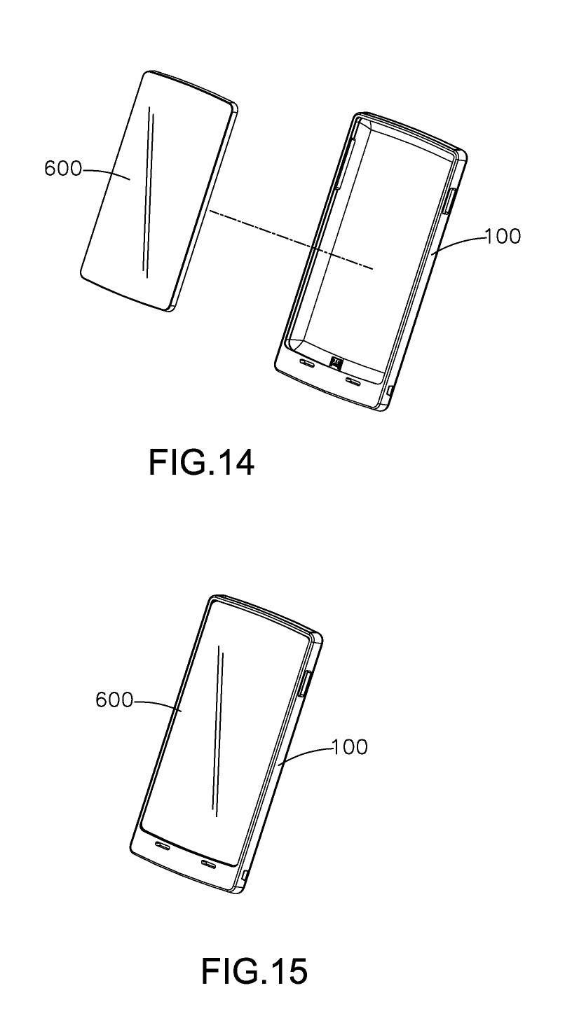

FIGS. 14-15 illustrated a straight perspective view of the memory expansion apparatus referred to the status before/ after connecting with a portable device.

As shown in FIGS. 14-15, the present invention is mainly used to connect with a portable device 600. The memory expansion apparatus 100 is configured to be suitable for portable device so the appearance is designed as consumer-approach and the dimension takes account into portable weight. After connecting with a portable device, the apparatus 100 accommodates the portable device 600 properly.

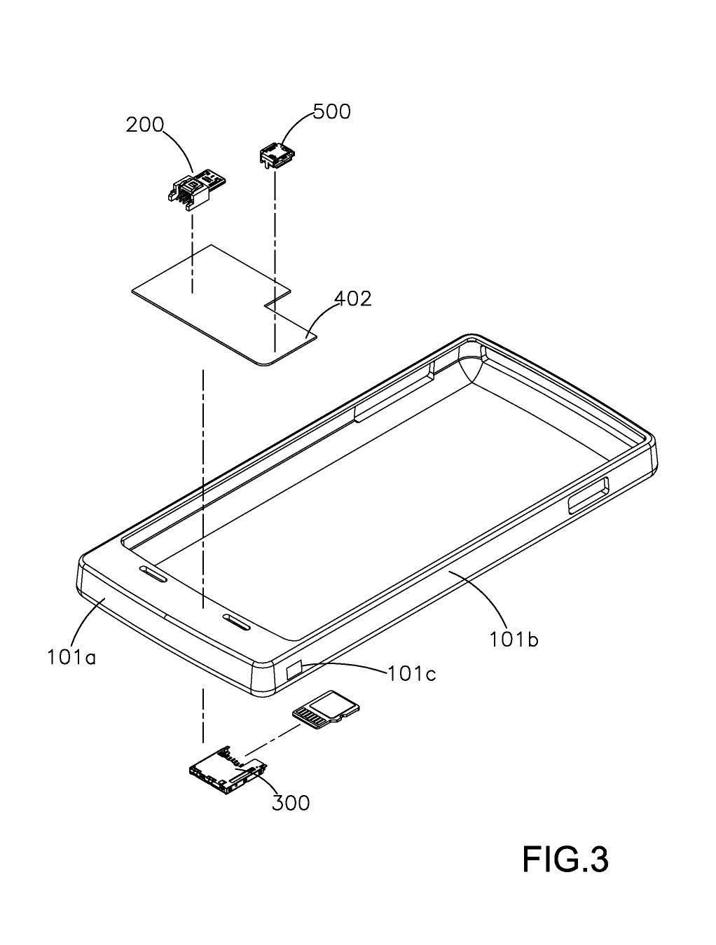

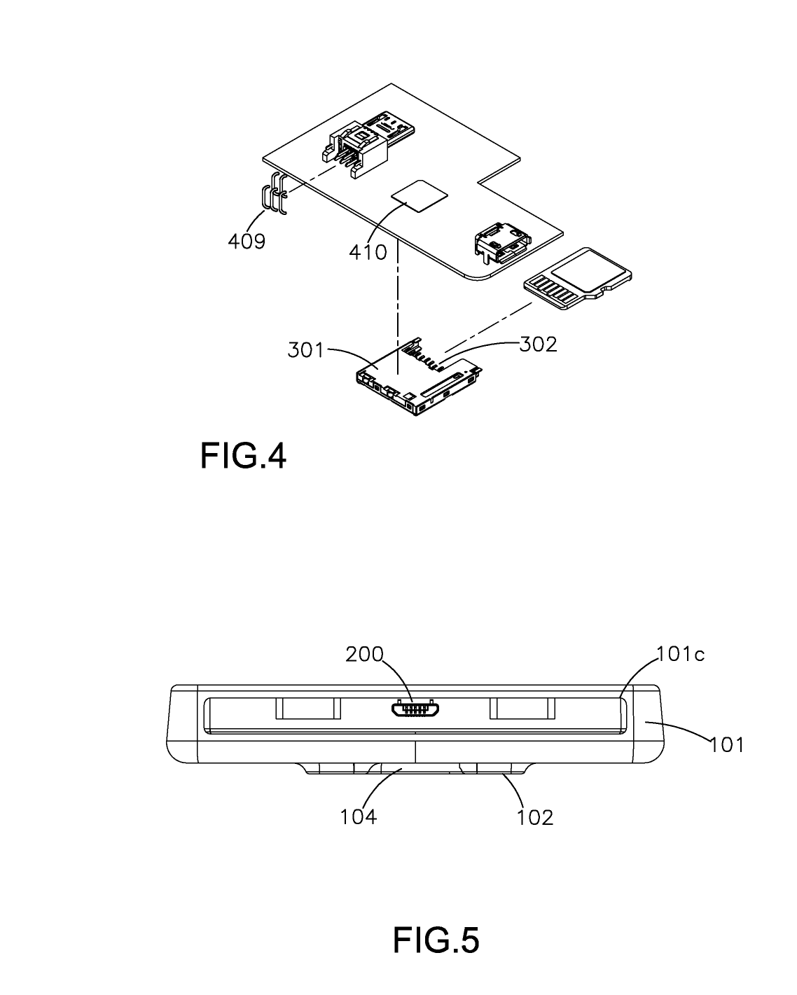

FIG. 3 is an exploded perspective view of the memory expansion apparatus formed in accordance with an embodiment of the invention. FIG. 4 is a top perspective view of PCB parts of the memory expansion apparatus.

As shown in FIGS. 3-4, the chassis 101 consists of a body 101a and frame 101b. The frame 101b of chassis 101 provides surrounding edges for accommodation; the body 101a of chassis 101 provides a section for installing the elements of the memory expansion apparatus 100. The memory expansion apparatus 100 comprises a printed circuit board (PCB) 402 configuring a principle interface 200, a loading interface 300 and a supplementary interface 500. In the present embodiment, the principle interface 200 and the supplementary interface 500 utilize I/O connectors for transmitting power and signals. The loading interface 300 utilizes a card connector for transmitting signals came out of an external memory card.

The principle interface 200, as a connector, is connecting to the PCB 402 with a plurality of terminals 409. The supplementary interface 500 is connecting to the PCB 402 with methods, such as through hole (DIP) or surface mount (SMT). The loading interface 300 includes a case 301 and a (card) chamber 302 to form a card connector. A microprocessor 410 mounted upon the PCB 402 is arranging and communicates with those interfaces above.

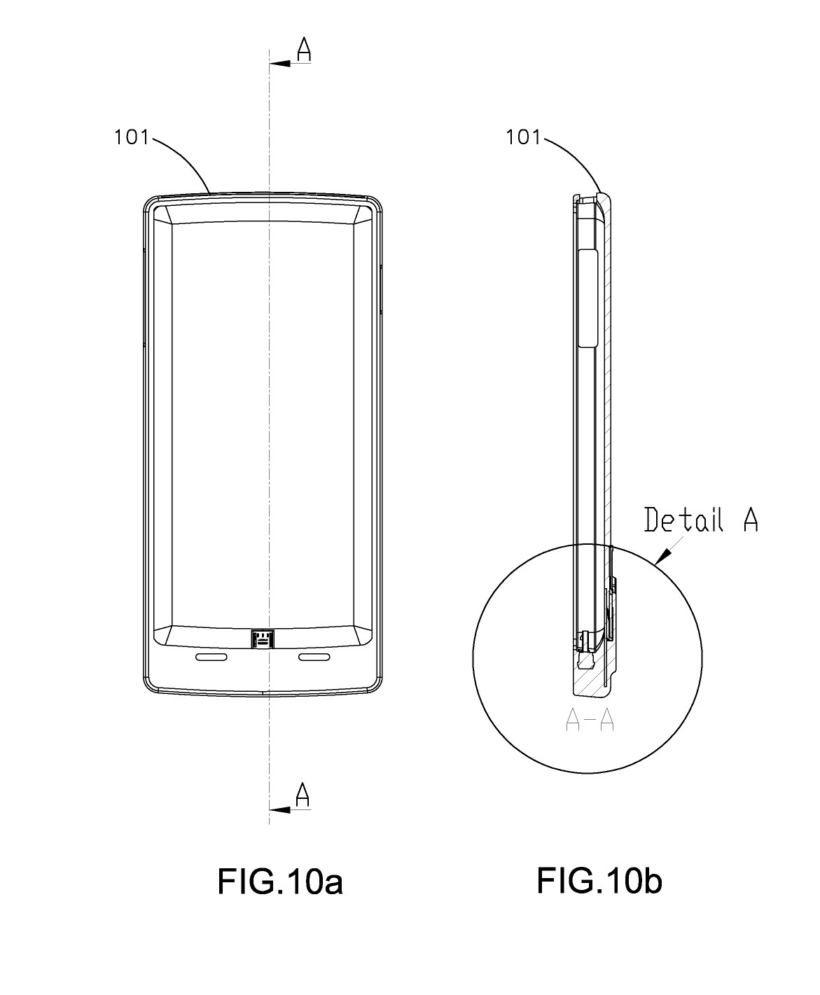

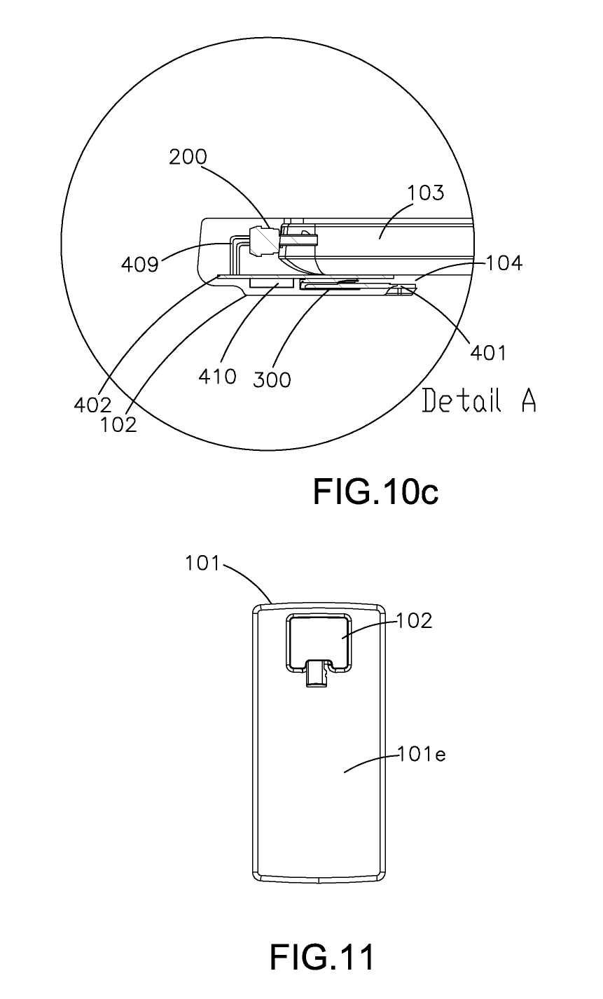

FIG. 10a is a front view of the memory expansion apparatus formed in accordance with an embodiment of the invention. FIG. 10b is a cross-section view of the memory expansion apparatus taken along line A-A in FIG. 10a.

FIG. 10c is a cross-section view illustrated details of the memory expansion apparatus shown in FIG. 10b Detail A.

As shown in FIGS. 10a-10c, the principle interface 200, which is soldered with a plurality of terminals 409 to board, is disposed to the body 101a of chassis 101 and exposes in the receiving space 103. Then, the loading interface 300 is disposed under board, wherein a memory card 401 is inserted into the loading interface 300 which is located within the protrude portion 102. The protrude portion 102 of chassis 101 is configured with an opening 104 for allowing the insertion of the memory card 401. A microprocessor 410 communicating with those interfaces is mounted to whichever above/ under board.

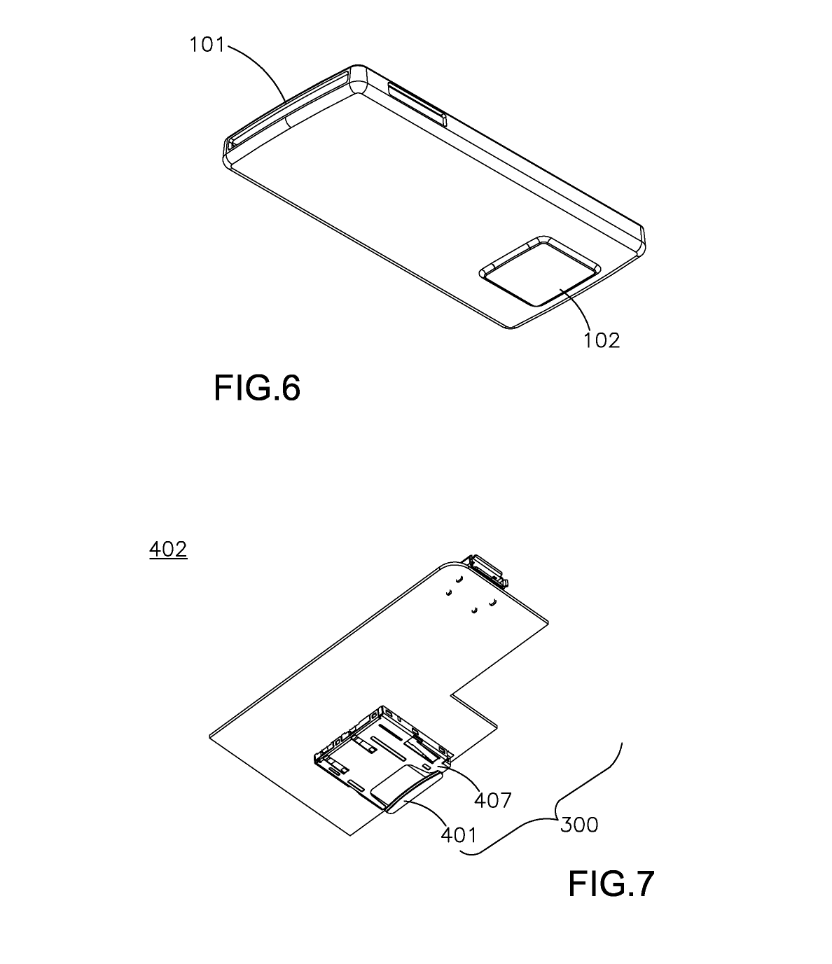

FIG. 5 is a top view of the memory expansion apparatus shown in FIG. 1. FIG. 6 is another bottom perspective view of the memory expansion apparatus formed in accordance with an embodiment of the invention.

As shown in FIGS. 5-6, the principle interface 200, which is exposed in the receiving space 103, can be observed through the recession 101c provided on the top of the memory expansion apparatus 100. The principle interface 200 is particularly provided via a cavity 101d. (see FIG. 1) The protrude portion 102 of chassis 101 and the configured opening 104 is generated at back of apparatus 100. However, the protrude portion 102 is further provided without configuring with an opening 104. See FIG. 6, the opening 104 is sealed and the protrude portion 102 is a pure protrusion. The detail of the embodiment is written in following description.

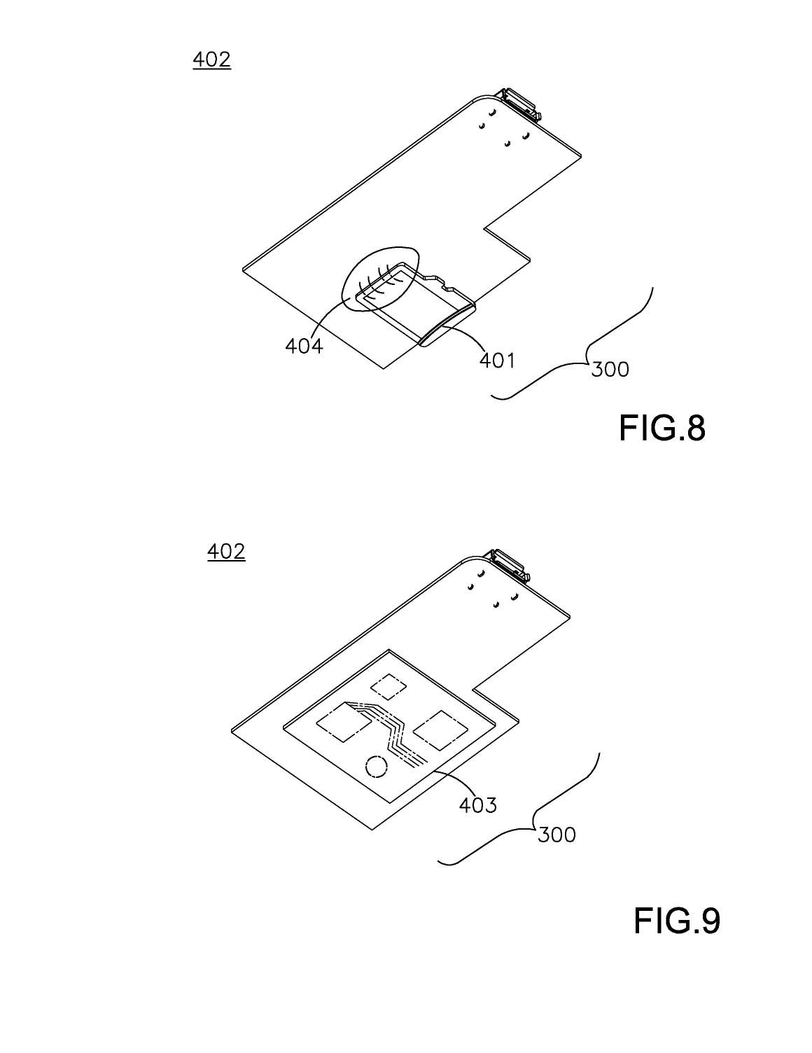

FIG. 7 is a bottom perspective view of PCB parts of the memory expansion apparatus formed in accordance with an embodiment of the invention. FIG. 8 is further a bottom perspective view of PCB parts of the memory expansion apparatus. FIG. 9 is another bottom perspective view of PCB parts of the memory expansion apparatus.

As shown in FIGS. 7-9, the loading interface 300 is able to practice in different way, depends the requirement and the cost of product, by the technologies today. As a card connector 407 mentioned above, the memory card 401 is inserted into the connector 407 for providing expansive memory to the memory expansion apparatus 100. In this way, the card connector 407 is mounted to PCB so that the memory card 401 is removable. In the condition of long-lasting embedding memory card 401, a wire-bonding method can be applied that providing a bonding portion 404 to disposing and connecting memory card 401 to PCB. In the recent year, a new technology been widely used is chip on board (COB) or system in package (SIP) that integrated microprocessor, memory and other electronic components in one package or the like material. So the electrical board 403 is mounted on PCB for providing expansive memory to the memory expansion apparatus 100 formed in accordance with an embodiment of the invention.

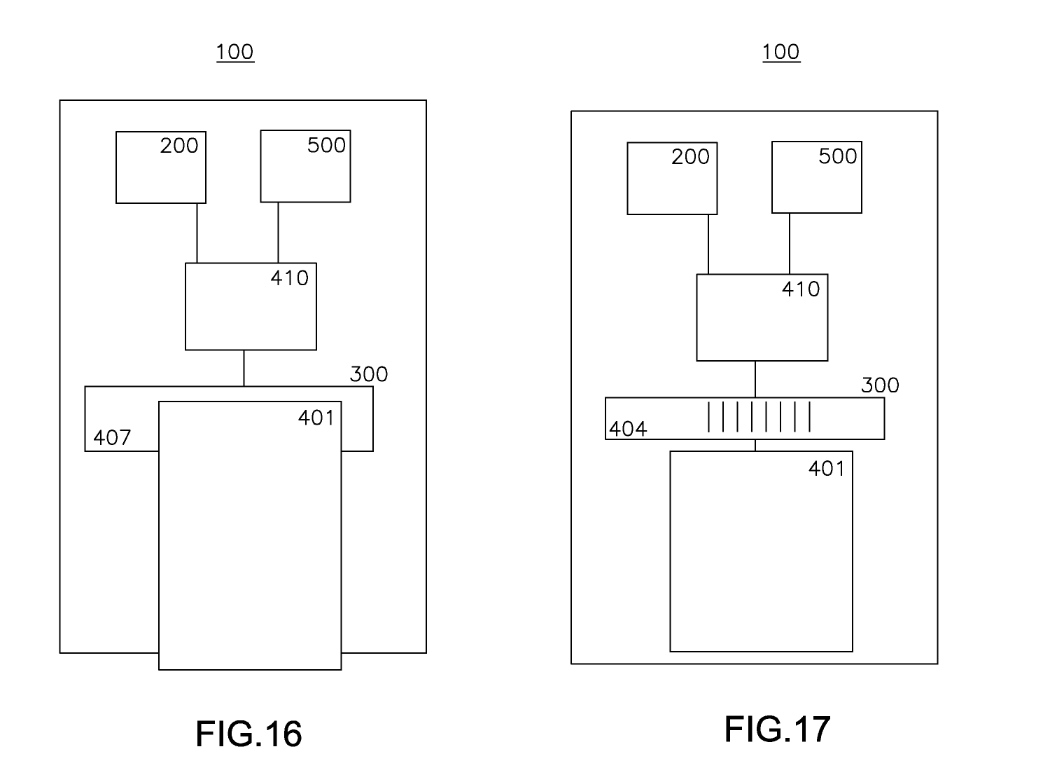

FIGS. 16-18 is block diagrams of the memory expansion apparatus formed in accordance with an embodiment of the invention.

As shown in FIG. 16, the memory expansion apparatus 100 includes a principle interface 200, a supplementary interface 500 and a loading interface 300. The microprocessor 410 communicates the interfaces 200, 300, 500, wherein the loading interface 300 is provided with a card connector 407. An external memory card 401 is inserted into the card connector 407 for providing expansive memory to the memory expansion apparatus 100. The physical feature is generally illustrated in FIG. 7. Additionally, the supplementary interface 500 is working as an electric-charging port or other I/O port to the memory expansion apparatus 100. As an electric-charging port, the external cable plug is inserted in the supplementary interface 500 via a recession 101c (see FIG. 3) so that the power voltage can be transmitting into the portable device assembled with the memory expansion apparatus 100 as status of use.

As shown in FIG. 17, the memory expansion apparatus 100 includes a principle interface 200, a supplementary interface 500 and a loading interface 300. The microprocessor 410 communicates the interfaces 200, 300, 500, wherein the loading interface 300 is provided with a bonding portion 404. An external memory card 401 is embedded into the memory expansion apparatus 100 for providing expansive memory to the memory expansion apparatus 100. The physical feature is generally illustrated in FIG. 8.

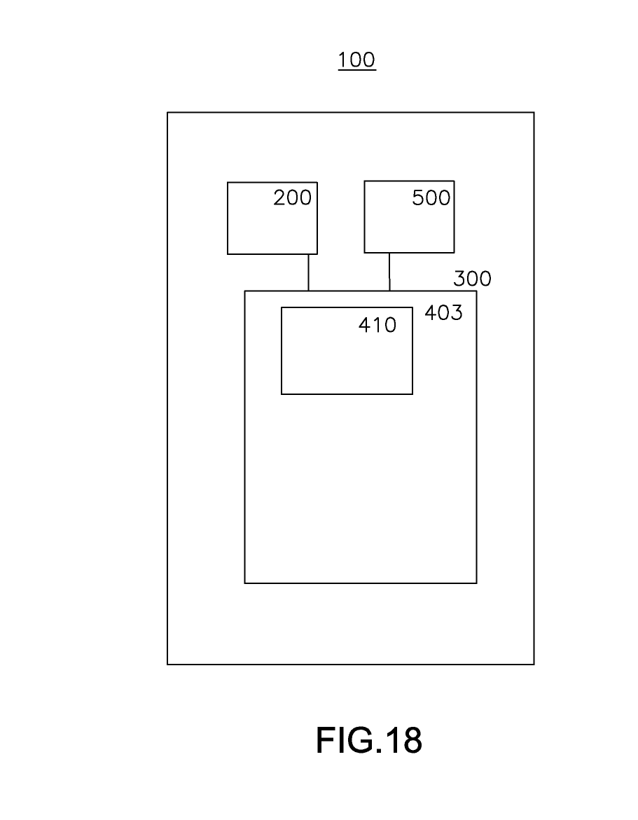

As shown in FIG. 18, the memory expansion apparatus 100 includes a principle interface 200, a supplementary interface 500 and a loading interface 300. The microprocessor 410 communicates the interfaces 200, 300, 500, wherein the loading interface 300 is replaced with an electrical board 403. The electrical board 403 is chip on board (COB) or system in package (SIP) that integrated microprocessor 410, memory and other electronic components in one package. An electrical board 403 is embedded into board (or be one of it) for providing expansive memory to the memory expansion apparatus 100. The physical feature is generally illustrated in FIG. 9.

FIG. 11 is a reverse rear view of the memory expansion apparatus formed in accordance with an embodiment of the invention.

A protrude portion 102 is configured on the back 101e of the chassis 101. The chassis 101 is being merely a casing element without other function.

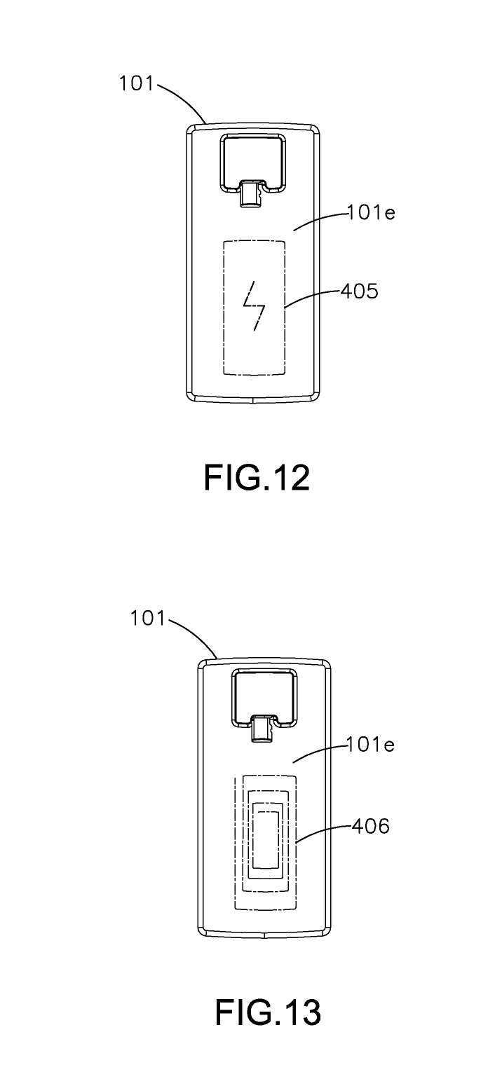

FIG. 12 is a further reverse rear view of the memory expansion apparatus formed in accordance with an embodiment of the invention.

A battery module 405 is configured on the back 101e of the chassis 101. The chassis 101 is not merely a casing but an element with battery function providing electric-charging to portable device.

FIG. 13 is another reverse rear view of the memory expansion apparatus formed in accordance with an embodiment of the invention.

A wiring 406 is configured on the back 101e of the chassis 101. The chassis 101 is not merely a casing but an element with antenna function providing electromagnetic-radiation to portable device.

While the invention has been described in terms of various specific embodiments, those skilled in the art will recognize that the invention can be practiced with modification within the spirit and scope of the claims.

What is claimed is:

1. A memory expansion apparatus, comprising:
a chassis, wherein a receiving space is generated in one side of the same; and
a printed circuit board (PCB) configuring a principle interface and a loading interface, said PCB mounting within said chassis, two interfaces sharing no common export; and
a memory article is provided with said loading interface,
wherein said principle interface exposing in said receiving space.

2. The memory expansion apparatus of claim 1, wherein said chassis consists of a body and frame.

3. The memory expansion apparatus of claim 1, wherein a plurality of recessions is disposed with the edges of the chassis facing said receiving space.

4. The memory expansion apparatus of claim 3, wherein one edge particularly disposes a cavity.

5. The memory expansion apparatus of claim 1, wherein said memory article is an external memory card is movably attached to back of apparatus.

6. The memory expansion apparatus of claim 1, wherein said printed circuit board further configuring a supplementary interface.

7. The memory expansion apparatus of claim 1, wherein said principle interface is configured with an I/O connector.

8. The memory expansion apparatus of claim 1, wherein said loading interface 300 is configured with a card connector.

9. The memory expansion apparatus of claim 8, wherein said loading interface includes a case and a chamber to form a card connector.

10. The memory expansion apparatus of claim 8, wherein a microprocessor is mounted upon the PCB.

11. The memory expansion apparatus of claim 1, wherein said loading interface 300 is located within the protrude portion.

12. The memory expansion apparatus of claim 1, wherein said principle interface is disposed to said PCB.

13. The memory expansion apparatus of claim 1, wherein said loading interface is disposed under said PCB.

14. The memory expansion apparatus of claim 11, wherein said protrude portion is configured with an opening.

15. The memory expansion apparatus of claim 1, wherein said loading interface 300 provided with a bonding portion.

16. The memory expansion apparatus of claim 1, wherein said loading interface is configured with an electrical board, which is adopted by chip on board (COB) or system in package (SIP).

17. The memory expansion apparatus of claim 16, wherein said electrical board integrating a microprocessor, memory and other electronic components in one package.

18. The memory expansion apparatus of claim 1, wherein a battery module is configured on the back of the chassis.

19. The memory expansion apparatus of claim 1, wherein a wiring is configured on the back of the chassis.
